(19) United States
(12) Patent Application Publication
(10) Pub. No.: US 2024/0388865 A1
(43) Pub. Date: Nov. 21, 2024

(54) INFORMATION PROCESSING DEVICE, INFORMATION PROCESSING METHOD, AND PROGRAM

(71) Applicant: Sony Group Corporation, Tokyo (JP)

(72) Inventors: Kenichi Makino, Kanagawa (JP); Kyosuke Matsumoto, Kanagawa (JP); Osamu Nakamura, Saitama (JP); Shinpei Tsuchiya, Saitama (JP)

(73) Assignee: Sony Group Corporation, Tokyo (JP)

(21) Appl. No.: 18/692,154

(22) PCT Filed: Mar. 14, 2022
(86) PCT No.: PCT/JP2022/011325

§ 371 Date: Mar. 14, 2024

(30) Foreign Application Priority Data
Sep. 21, 2021 (JP) 2021-152892

(51) Int. Cl. H04S 7/00; H04R 25/00

(52) U.S. Cl. CPC H04S 7/302; H04R 25/505; H04S 7/307; H04S 2400/11; H04S 2420/01

(57) ABSTRACT

The present technology relates to an information processing device, an information processing method, and a program enabling a person with hearing loss to suitably hear sound having sound image localization.

Stereophonic sound data having sound image localization is generated on the basis of the direction of a sound source arranged in a virtual space, data conversion processing corresponding to an auditory characteristic of a user is performed on the stereophonic sound data, and output sound data to be heard by the user is generated.

### TECHNICAL FIELD

The present technology relates to an information processing device, an information processing method, and a program, and more particularly, to an information processing device, an information processing method, and a program that enable a person with hearing loss to suitably hear a sound having sound image localization.

### BACKGROUND ART

According to Non-Patent Document 1, a human is said to perceive a direction by using a peak and a notch on a frequency axis of a transfer characteristic that changes for each sound arrival direction as clues, and it is known that a head-related transfer function (HRTF) is individually optimized to obtain high sound image localization with headphones or the like.

### CITATION LIST

### Non-Patent Document

Non-Patent Document 1: Yoji ISHII, Hironori TAKEMOTO, Kazuhiro IIDA, “Mystery of auricle shape and head-related transfer function”, Journal of the Acoustical Society of Japan, 2015, Vol. 71, No. 3, pp. 127-135

### SUMMARY OF THE INVENTION

### Problems to be Solved by the Invention

A person with hearing loss hears sound by correcting sound data with a hearing aid according to the auditory characteristic, but if sound data having sound image localization is corrected with a hearing aid, sound image localization cannot be perceived in some cases.

The present technology has been made in view of such a situation, and enables a person with hearing loss to suitably hear a sound having sound image localization.

### Solutions to Problems

An information processing device or a program of the present technology is an information processing device including: a rendering processing unit that generates stereophonic sound data having sound image localization on the basis of a direction of a sound source arranged in a virtual space; and a signal processing unit that performs data conversion processing corresponding to an auditory characteristic of a user on the stereophonic sound data generated by the rendering processing unit and generates output sound data to be heard by the user, or a program for causing a computer to function as such an information processing device.

An information processing method of the present technology is an information processing method for an information processing device including a rendering processing unit and a signal processing unit, the information processing method including: by the rendering processing unit, generating stereophonic sound data having sound image localization on the basis of a direction of a sound source arranged in a virtual space; and by the signal processing unit, performing data conversion processing corresponding to an auditory characteristic of a user on the stereophonic sound data generated by the rendering processing unit and generating output sound data to be heard by the user.

In the information processing device, the information processing method, and the program of the present technology, stereophonic sound data having sound image localization is generated on the basis of a direction of a sound source arranged in a virtual space, data conversion processing corresponding to an auditory characteristic of a user is performed on the stereophonic sound data, and output sound data to be heard by the user is generated.

### BRIEF DESCRIPTION OF DRAWINGS

FIG. 1 is a block diagram illustrating a configuration example of an information processing system to which the present technology is applied.

FIG. 2 is a block diagram exemplifying a configuration of processing units included in the information processing system.

FIG. 3 is a diagram illustrating processing content of a multiband compressor in a signal processing unit for a person with hearing loss.

FIG. 4 is a view illustrating an example of a user interface unit.

FIG. 5 is a view illustrating an example of the user interface unit.

FIG. 6 is a view illustrating an example of the user interface unit.

FIG. 7 is a block diagram illustrating a configuration example of the information processing system in a case where a person with normal hearing hears sound source data of content with 3D metadata in 3D audio.

FIG. 8 is a block diagram illustrating a configuration example of the information processing system in a case where a person with hearing loss hears sound source data of content with 3D metadata in 3D audio.

FIG. 9 is a flowchart exemplifying a procedure for adjusting a parameter of a signal processing unit for a person with hearing loss.

FIG. 10 is an explanatory diagram for explaining processing of reproducing a plurality of pieces of sound source data for a person with normal hearing corresponding to a plurality of sound sources.

FIG. 11 is an explanatory diagram for explaining a first form of processing of reproducing a plurality of pieces of sound source data for a person with hearing loss.

FIG. 12 is an explanatory diagram for explaining a second form of the processing of reproducing the plurality of pieces of sound source data for a person with hearing loss corresponding to the plurality of sound sources.

FIG. 13 is an explanatory diagram for explaining adjustment of a parameter for signal processing for a person with hearing loss used in the second form of processing of reproducing a plurality of pieces of voice data.

FIG. 14 is an explanatory diagram for explaining generation of a parameter set for signal processing for a person with hearing loss used in the second form of the processing of reproducing the plurality of pieces of voice data.

FIG. 15 is a diagram illustrating a method of adjusting the parameter for signal processing for a person with hearing loss in the second form of the processing of reproducing the plurality of pieces of voice data.

FIG. 16 is a flowchart exemplifying a procedure of a first form of adjustment of the parameter for signal processing for a person with hearing loss in the second form of the processing of reproducing the plurality of pieces of voice data.

FIG. 17 is a flowchart illustrating a procedure of a second form of adjustment of the parameter for signal processing for a person with hearing loss in the second form of the processing of reproducing the plurality of pieces of voice data.

FIG. 18 is a flowchart exemplifying an overall procedure for adjustment of the parameter for signal processing for a person with hearing loss using the procedure of FIG. 17.

FIG. 19 is a flowchart exemplifying a procedure in a case where the parameter for signal processing for a person with hearing loss corresponding to an angle included in an angle set S is adjusted again.

FIG. 20 is a block diagram illustrating a configuration example of hardware of a computer that executes a series of processing by a program.

### MODE FOR CARRYING OUT THE INVENTION

Hereinafter, embodiments of the present technology will be described with reference to the drawings.

### <Embodiment of Information Processing System>

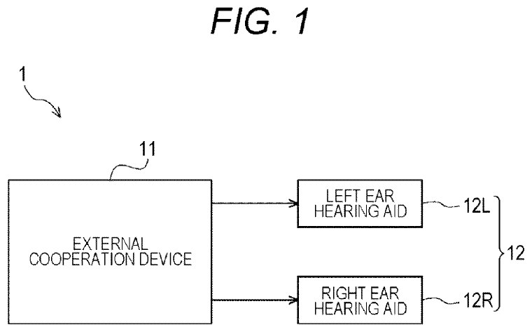

FIG. 1 is a block diagram illustrating a configuration example of an information processing system to which the present technology is applied.

In FIG. 1, an information processing system 1 includes an external cooperation device 11 and a hearing aid 12. The external cooperation device 11 and the hearing aid 12 are connected so as to be able to transmit a signal in a wired or wireless manner.

The external cooperation device 11 is an arbitrary signal processing device such as a smartphone, a smart watch, a personal computer (PC), a head mounted display (HMD), or the like. The external cooperation device 11 supplies left sound data (stereophonic sound data) (for left ear) and right sound data (for right ear) in 3D audio having sound image localization to the hearing aid 12. 3D audio (stereophonic audio) refers to a method of reproducing a three-dimensional sound direction, distance, spread, or the like when reproducing the sound.

The hearing aid 12 includes a left ear hearing aid 12L that is worn on the left ear by a person with hearing loss and outputs a sound (output sound data) to be heard by the left ear, and a right ear hearing aid 12R that is worn on the right ear by the person with hearing loss and outputs a sound (output sound data) to be heard by the right ear. In the hearing aid 12, for example, a multiband compressor that compresses the input and output characteristic of a sound with a frequency that is difficult to be heard by each of the left ear and the right ear of a person with hearing loss is used. The left ear hearing aid 12L and the right ear hearing aid 12R execute processing by the multiband compressors on the left sound data and the right sound data supplied from the external cooperation device 11, respectively, and output the processed sound data as sound waves from sound output units.

### <Block Diagram of Information Processing System 1>

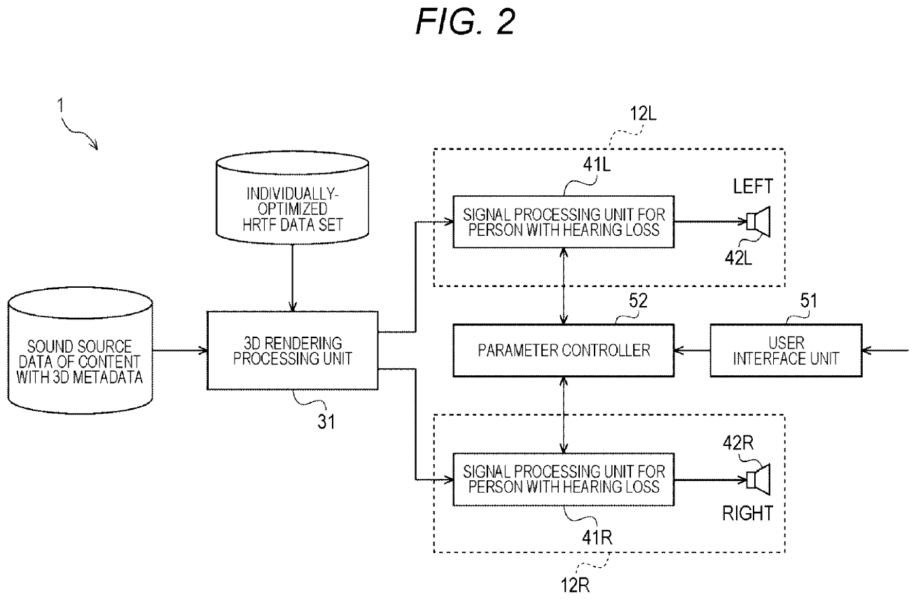

FIG. 2 is a block diagram exemplifying a configuration of processing units included in the information processing system 1. In FIG. 2, the information processing system 1 includes a 3D rendering processing unit 31, signal processing units 41L and 41R for a person with hearing loss, sound output units 42L and 42R, a user interface unit 51, and a parameter controller 52.

The 3D rendering processing unit 31 is arranged, for example, in the external cooperation device 11. The 3D rendering processing unit 31 performs 3D rendering processing on the basis of sound source data included in content with 3D metadata, and generates sound data (stereophonic sound data) in stereophonic audio. Content with 3D metadata is, for example, information of a virtual object, a virtual sound source (hereinafter, simply referred to as a sound source), or the like in a virtual space in which a virtual world such as virtual reality (VR) or augmented reality (AR) is formed. 3D metadata includes data related to arrangement of an object such as the position and posture of a virtual object arranged in the virtual space, or the position or direction of the sound source. In the present embodiment, as content with 3D metadata, only a sound source to which data of the direction of the sound source in a virtual space is added is focused on, and sound data generated from the sound source is referred to as sound source data. The direction of the sound source is also referred to as the angle of the sound source with the front direction of the user as a reference (0 degrees). In the description of the present embodiment, a description is given assuming that the sound source is arranged in a direction limited in a two-dimensional plane, but the present technology can be applied similarly to the present embodiment even in a case where the sound source is not limited in a two-dimensional plane and is arranged in a three-dimensionally extended direction.

The 3D rendering processing unit 31 acquires sound source data that is content with 3D metadata stored in advance in a storage unit (not illustrated) of the external cooperation device 11. However, the sound source data may be supplied to the external cooperation device 11 (3D rendering processing unit 31) via a communication line such as the Internet, and the path through which the sound source data is supplied to the 3D rendering processing unit 31 may have any form.

The 3D rendering processing unit 31 acquires a head related transfer function (HRTF) corresponding to the angle of the sound source from an individually-optimized HRTF data set on the basis of the data of the direction (angle) of the sound source added to the acquired sound source data. The individually-optimized HRTF data set is stored in advance in the storage unit (not illustrated) of the external cooperation device 11. The head related transfer function represents a transfer function until a sound wave generated from the sound source reaches each of the left ear and the right ear of the user. The head related transfer function changes according to the direction of the sound source with respect to the user's head (the arrival direction in which the sound wave arrives at the user's head), and is also different for the left ear and the right ear. The head related transfer function differs depending on the user, and it is assumed that the user-specific left head related transfer function (for left ear) and the user-specific right head related transfer function (for right ear) are created in advance as the individually-optimized HRTF data set for each direction of the sound source and stored in the storage unit. Note that, as the head related transfer function, an average function common to all users may be used instead of the head related transfer function optimized for each user. As is well known, the head related transfer function corresponds to a Fourier transform of a head-related impulse response (HRIR) represented in a frequency domain, the HRIR representing a sound wave heard by each of the left ear and the right ear in a case where one impulse is generated at the position of the sound source.

The 3D rendering processing unit 31 generates left sound data and right sound data from the sound source data from the storage unit and the left head related transfer function and the right head related transfer function corresponding to the direction (angle) of the sound source added to the sound source data. Specifically, the 3D rendering processing unit 31 generates left sound data obtained by convolution integration of the sound source data and the left head-related impulse response on the basis of the sound source data and the left head related transfer function. In the convolution integration of the sound source data and the left head-related impulse response, the sound source data is subjected to frequency conversion from the time domain representation to the frequency domain representation, and then the sound source data in the frequency domain and the left head related transfer function are multiplied in the same frequency components. The data of the frequency components thus obtained is subjected to inverse Fourier transform to generate left sound data. The same applies to generation of right sound data. Hereinafter, in the case of simply referring to the head related transfer function, the head-related impulse response, or the sound data without limitation of left or right, the head related transfer function, the head-related impulse response, or the sound data represent each of the left and right head related transfer function, each of the left and right head-related impulse response, or each of the left and right sound data, respectively. The convolution integration of the sound source data and the head-related impulse response is also referred to as a convolution integration of the sound source data and the head related transfer function. The sound source data and the sound data generated by the 3D rendering processing unit 31 may also be data represented not in the time domain but in the frequency domain, and in the following, it is not distinguished whether the data is represented in the time domain or the frequency domain.

The 3D rendering processing unit 31 supplies the generated left sound data and right sound data to the signal processing units 41L and 41R for a person with hearing loss, respectively.

The signal processing units 41L and 41R for a person with hearing loss are arranged in, for example, the left ear hearing aid 12L and the right ear hearing aid 12R, respectively. The signal processing unit 41L for a person with hearing loss executes processing (compression processing) of the multiband compressor on the left sound data from the 3D rendering processing unit 31. The signal processing unit 41R for a person with hearing loss executes processing (compression processing) of the multiband compressor on the right sound data from the 3D rendering processing unit 31. The processing of the multiband compressor is processing of dividing the entire frequency domain (for example, the entire audible range) of the sound data into a plurality of frequency bands, converting the input level (amplitude level) of the input sound data according to the input and output characteristic for each frequency band, and outputting the converted sound data.

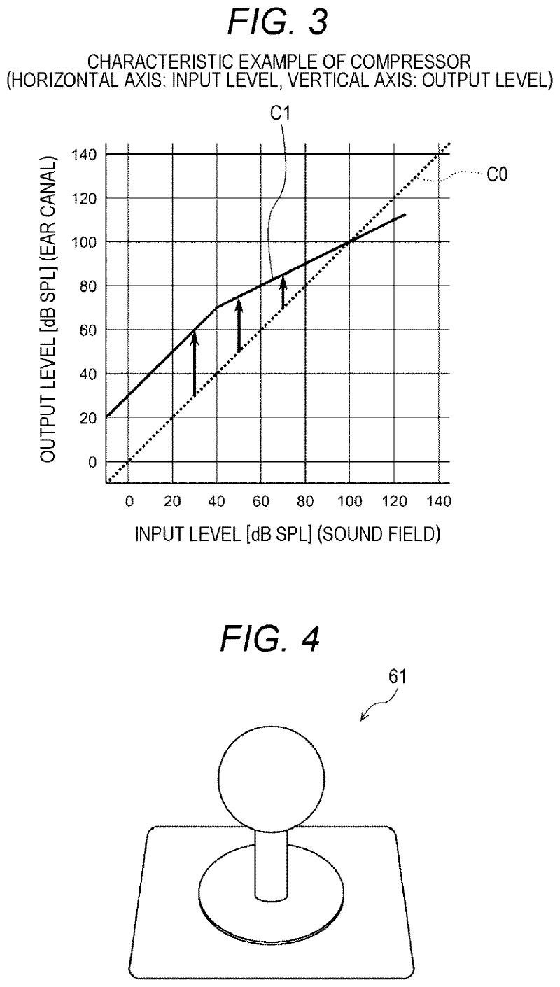

FIG. 3 is a diagram illustrating processing content of the multiband compressor in each of the signal processing units 41L and 41R for a person with hearing loss. FIG. 3 exemplifies the input and output characteristic of the multiband compressor regarding a predetermined frequency band (focused-on frequency band). Graph line C0 indicates the input and output characteristic of the multiband compressor in a case where the output level (amplitude level) of the output signal is one time the input level (amplitude level) of the input signal (sound data). In this case, sound data from the 3D rendering processing unit 31, which is an input signal to the multiband compressor, is output as it is as an output signal from the multiband compressor. In contrast, graph line C1 indicates the input and output characteristic of the multiband compressor in a case where the dynamic range of the output signal is compressed in accordance with the characteristic (auditory characteristic) of the hearing loss of the user in a case where the user is a person with hearing loss. According to this, as the amplitude level of the sound data that is the input signal is smaller, the sound data is amplified by the multiband compressor with a higher amplification factor and output as the output signal. The input and output characteristic of the multiband compressor in the predetermined frequency band represents an example of the input and output characteristic applied to a user who has difficulty in perceiving sound in the frequency band. According to the input and output characteristic of the multiband compressor, the dynamic range of the output signal is compressed with respect to the dynamic range of the input signal.

Each of the signal processing units 41L and 41R for a person with hearing loss executes processing of the multiband compressor as described above. The auditory characteristic is different for each user and for each frequency (for each frequency band). The auditory characteristic is also different between the left ear and the right ear. Therefore, the input and output characteristics of the multiband compressors in the signal processing units 41L and 41R for a person with hearing loss are set to be input and output characteristics adapted to the auditory characteristics of the left ear and the right ear for each user and for each frequency band. In the present embodiment, the setting or change of the input and output characteristic of the multiband compressor in each of the signal processing units 41L and 41R for a person with hearing loss is performed by adjusting the value of the parameter for signal processing for a person with hearing loss specifying (determining) the input and output characteristic. However, processing of the signal processing units 41L and 41R for a person with hearing loss is not limited to processing of the multiband compressor, and may be any processing that performs data conversion processing of converting input sound data into sound data for a person with hearing loss. Also in this case, it is assumed that the processing characteristic of the signal processing units 41L and 41R for a person with hearing loss is set or changed by adjusting the value of the parameter for signal processing for a person with hearing loss, and the signal processing units 41L and 41R for a person with hearing loss perform the data conversion processing of the characteristic corresponding to the auditory characteristic of the user. The parameter for signal processing for a person with hearing loss is also simply referred to as a parameter.

In FIG. 2, sound data processed by the signal processing unit 41L for a person with hearing loss and sound data processed by the signal processing unit 41R for a person with hearing loss are supplied to sound output units 42L and 42R, respectively, as output sound data to be heard by the user.

The sound output units 42L and 42R are arranged in the left ear hearing aid 12L and the right ear hearing aid 12R, respectively. In the left ear hearing aid 12L worn on the left ear of the user, the sound output unit 42L outputs sound data from the signal processing unit 41L for a person with hearing loss to the left ear of the user as a sound wave. In the hearing aid 12R worn on the right ear of the user, the sound output unit 42R outputs sound data from the signal processing unit 41R for a person with hearing loss to the right ear of the user as a sound wave.

Note that all of the 3D rendering processing unit 31 and the signal processing units 41L and 41R for a person with hearing loss may be arranged in the external cooperation device 11 or may be arranged in the hearing aid 12.

The user interface unit 51 is arranged, for example, in the external cooperation device 11. The user interface unit 51 is an operation input unit that receives a user's operation when adjusting the parameter of the signal processing units 41L and 41R for a person with hearing loss. In adjustment of the parameter of the signal processing units 41L and 41R for a person with hearing loss, for example, as described in detail later, the 3D rendering processing unit 31 generates left sound data and right sound data in 3D audio with respect to test sound source data generated in a test sound source (for adjustment). The left sound data and right sound data generated by the 3D rendering processing unit 31 are converted into left sound data and right sound data for a person with hearing loss by the signal processing units 41L and 41R for a person with hearing loss, respectively, and are output from the sound output units 42L and 42R, respectively. The user hears the sounds output from the sound output units 42L and 42R and inputs (specifies) the perceived direction (sound arrival direction) of the sound source (sound image) by the user interface unit 51. As a result, the parameter of the signal processing units 41L and 41R for a person with hearing loss is adjusted such that the direction of the sound source of the sound data generated by the 3D rendering processing unit 31 coincides with the direction of the sound source input from the user interface unit 51 by the user.

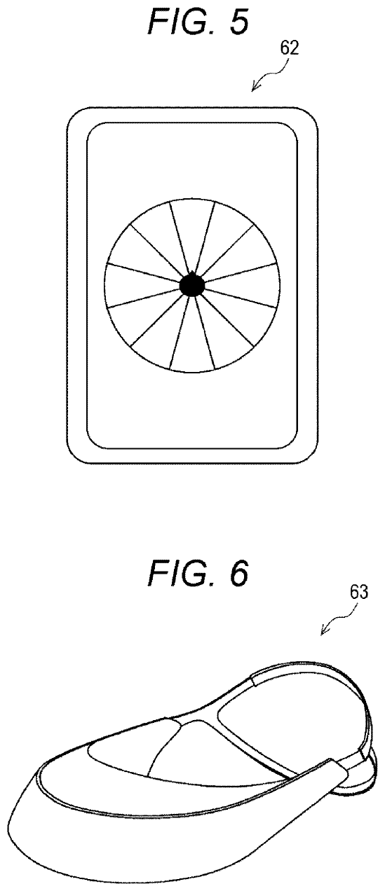

FIGS. 4 to 6 are views each illustrating an example of the user interface unit 51. The user interface unit 51 is desirably a device enabling a user to easily input the direction (sound arrival direction) of the sound source (sound image) of a sound that the user has heard. Therefore, a joystick 61 in FIG. 4, a touch panel 62 in FIG. 5, a head mounted display (HMD) 63 in FIG. 6, or the like is used as the user interface unit 51. In the case of using the joystick 61 of FIG. 4, the user specifies (inputs) the direction of the sound source of the sound that the user has heard by the tilt direction of the stick. In the case of using the touch panel 62 of FIG. 5, for example, a circle is displayed on the display on which the touch panel 62 is arranged, and line segments connecting the center of the circle and a plurality of points arranged at equal intervals on the circumference (line segments dividing the circle at every predetermined angle) are displayed. The user regards the center of the circle as a self-position, and touches a location in a predetermined direction with respect to the center of the circle on the touch panel (on the display screen) to specify (input) the perceived direction of the sound source. In a case where the HMD 63 of FIG. 6 is used, the user wears the HMD 63 on the head. Since the HMD 63 includes a sensor that detects the self-position and the posture, the user specifies (inputs) the perceived direction of the sound source by the direction in which the head is directed. Note that the user interface unit 51 is not limited to the input devices illustrated in FIGS. 4 to 6, and may be any other device such as a keyboard.

The parameter controller 52 is arranged in the external cooperation device 11, for example. The parameter controller 52 adjusts the value of the parameter of the signal processing units 41L and 41R for a person with hearing loss on the basis of information input from the user interface unit 51 by the user, or the like.

<Configuration Example of Information Processing System in Case where Person with Normal Hearing Hears Sound of 3D Audio>

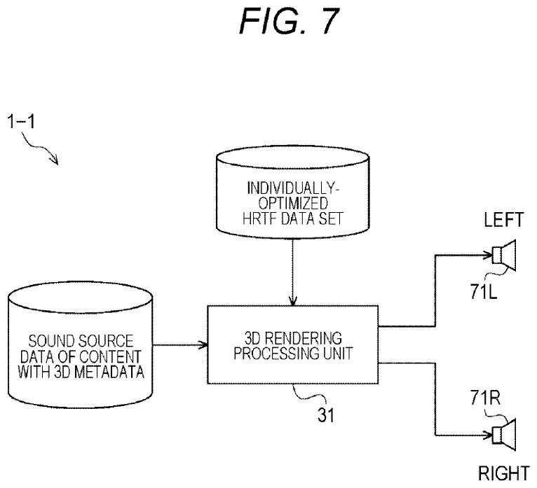

FIG. 7 is a block diagram illustrating a configuration example of an information processing system 1-1 in a case where a person with normal hearing hears sound source data of content with 3D metadata in 3D audio. Note that, in FIG. 7, portions corresponding to those of the information processing system 1 in FIG. 2 are denoted by the same reference signs, and a description thereof will be omitted.

In a case where a person with normal hearing hears sound source data of content with 3D metadata in 3D audio, a sound output device such as general earphones or headphones used by the person with normal hearing instead of the hearing aid 12 of FIG. 2 is connected to the external cooperation device 11 in a wired or wireless manner. The sound output device includes a left sound output unit 71L and a right sound output unit 71R that output sound data as sound waves. According to this, the left sound data and the right sound data in 3D audio generated by the 3D rendering processing unit 31 on the basis of the sound source data of the content with 3D metadata are output as sound waves from the left sound output unit 71L and the right sound output unit 71R to the left ear and the right ear of the user, respectively, without being processed by the signal processing units 41L and 41R for a person with hearing loss in FIG. 2. The user can hear sound in 3D audio having sound image localization.

<Configuration Example of Information Processing System in Case where Person with Hearing Loss Hears Sound in 3D Audio>

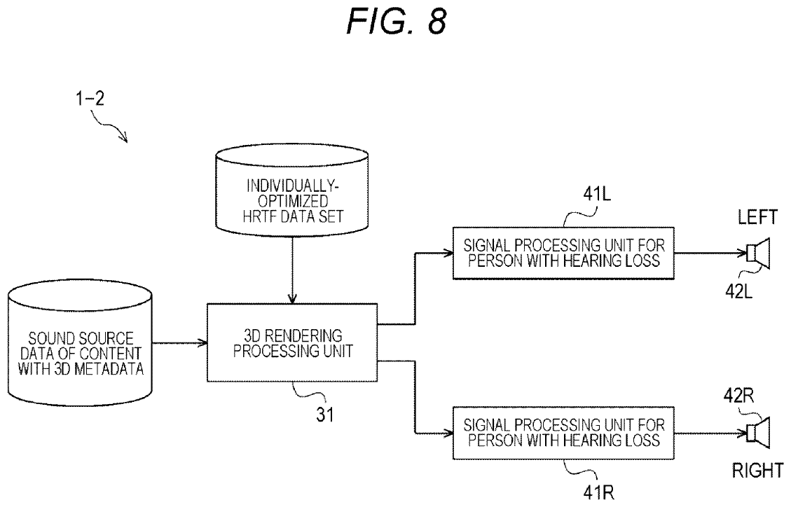

FIG. 8 is a block diagram illustrating a configuration example of an information processing system 1-2 in a case where a person with hearing loss hears sound source data of content with 3D metadata in 3D audio. Note that, in FIG. 7, portions corresponding to those of the information processing system 1 in FIG. 2 are denoted by the same reference signs, and a description thereof will be omitted.

In a case where a person with hearing loss hears sound source data of content with 3D metadata in 3D audio, the left ear hearing aid 12L and the right ear hearing aid 12R are connected to the external cooperation device 11 in a wired or wireless manner as illustrated in FIG. 2. According to this, left sound data and right sound data in 3D audio generated by the 3D rendering processing unit 31 on the basis of the sound source data of the content with 3D metadata are converted into left sound data and right sound data for a person with hearing loss by the processing of the multiband compressors of the signal processing units 41L and 41R for a person with hearing loss, respectively. The left sound data and the right sound data for a person with hearing loss obtained by conversion by the signal processing units 41L and 41R for a person with hearing loss are output as sound waves from the sound output units 42L and 42R to the left ear and the right ear of the user, respectively. At this time, the user, who is a person with hearing loss cannot always appropriately hear a sound in 3D audio having sound image localization. For example, in a case where the parameter (input and output characteristic of the multiband compressor) of the signal processing units 41L and 41R for a person with hearing loss is not adjusted for 3D audio, for example, in a case where the parameter is set to a value for hearing a sound that is not 3D audio, the user may not be able to appropriately perceive the direction of the sound source due to the influence of compression processing of the multiband compressor. That is, a peak or a notch of the frequency characteristic of the head related transfer function, which is a clue to sound image localization, may not be sufficiently perceived due to a decrease in hearing, and sense of localization is inhibited in some cases. In contrast, in a case where the multiband compressor enables a signal in a frequency band in which hearing decreases to be perceived, if a compression rate of the multiband compressor is high, a sound pressure difference of signals in the frequency band decreases. As a result, the peak or notch of the frequency characteristic of the head related transfer function cannot be sufficiently obtained, and the sense of localization is inhibited in some cases. Therefore, it is necessary to appropriately adjust the multiband compressor according to the symptoms of the person with hearing loss. Furthermore, in signal processing for a person with hearing loss for providing 3D audio for a person with hearing loss without being limited to the multiband compressor, a factor of an individual difference is strong in the symptoms of hearing loss in addition to an individual difference of the head related transfer function, and in order to obtain correct sound image localization in 3D audio by personalization of the head related transfer function, it is desirable to adjust the signal processing for the person with hearing loss.

Therefore, in the information processing system 1 of FIG. 2, the user interface unit 51 and the parameter controller 52 for adjusting the parameter of the signal processing units 41L and 41R for a person with hearing loss to a value suitable for 3D audio are provided.

Note that in the following, the value of the parameter (input and output characteristic of the multiband compressor) of the signal processing units 41L and 41R for a person with hearing loss in a case where the parameter is not adjusted for 3D audio is referred to as the value of the parameter of a hearing aid normally used by the user.

<Procedure for Adjusting Parameter of Signal Processing Units 41L and 41R for Person with Hearing Loss>

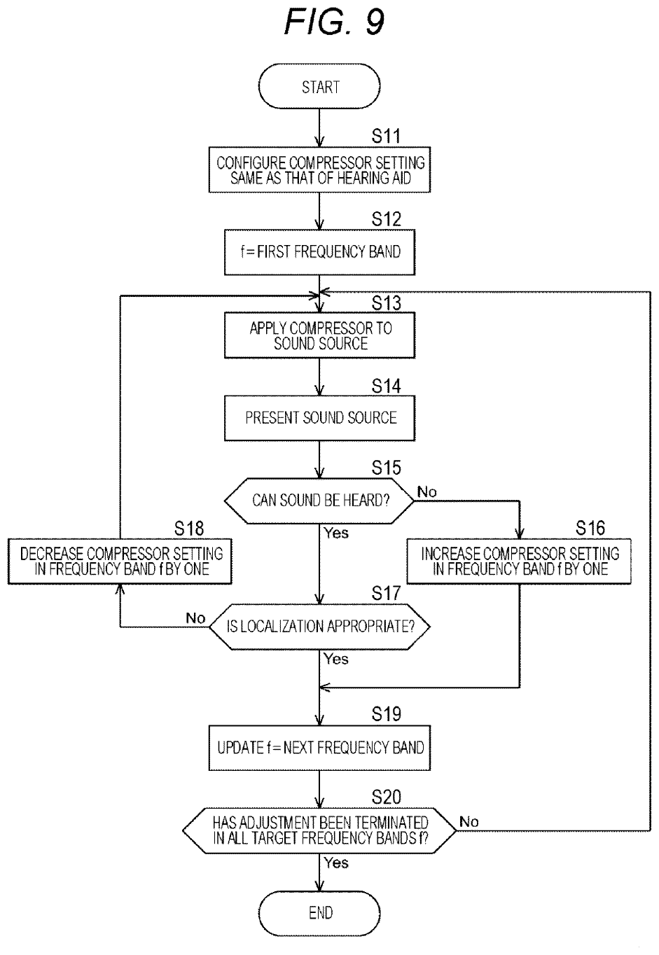

FIG. 9 is a flowchart exemplifying a procedure for adjusting the parameter of the signal processing units 41L and 41R for a person with hearing loss.

In FIG. 9, in step S11, the parameter controller 52 sets the initial value of the parameter of the signal processing units 41L and 41R for a person with hearing loss of the hearing aid 12 to the hearing aid normally used by the user and the value of the parameter. However, the initial value of the parameter of the signal processing units 41L and 41R for a person with hearing loss of the hearing aid 12 may be the value of a parameter adjusted for another user having an auditory characteristic similar to that of the user, or may be another value. In a case where the user does not have a hearing aid, the user may take a hearing test, and the value of the parameter obtained by applying a hearing aid fitting prescription formula to the result of the hearing test may be used. The processing proceeds from step S11 to step S12.

In step S12, the parameter controller 52 sets the frequency band f to be focused on as the first frequency band. Here, it is assumed that the parameter controller 52 divides the entire frequency range (for example, the entire audible range) allowed as an input signal (sound data) input to the multiband compressors of the signal processing units 41L and 41R for a person with hearing loss into a plurality of frequency bands and adjusts the parameter for each frequency band. The frequency band to be a parameter adjustment target may be some of the plurality of divided frequency bands. It is assumed that the order (turn) is given to each frequency band, for example, in descending order or ascending order of frequency. At this time, the frequency band f to be focused on represents the frequency band of the parameter to be adjusted, and the first frequency band represents the frequency band to which the first order is given among the orders (turns) given to the respective frequency bands. The processing proceeds from step S12 to step S13.

In step S13, the 3D rendering processing unit 31 generates left sound data and right sound data in 3D audio for the test sound source data generated from a test sound source for the user's head in the virtual space. The test sound source data may be sound data including frequency components in all the frequency bands to be a parameter adjustment target, or may be sound data including only frequency components in the focused-on frequency band f that is currently an adjustment target. The signal processing units 41L and 41R for a person with hearing loss apply processing of the multiband compressors to the left sound data and the right sound data generated by the 3D rendering processing unit 31, respectively. The processing proceeds from step S13 to step S14.

In step S14, the parameter controller 52 outputs left sound data and right sound data for a person with hearing loss generated by applying the processing of the multiband compressors of the signal processing units 41L and 41R for a person with hearing loss from the sound output units 42L and 42R, respectively, and presents the left sound data and the right sound data to the user. The processing proceeds from step S14 to step S15.

In step S15, the parameter controller 52 judges whether or not a sound can be heard on the basis of input information from the user interface unit 51. For example, in a case where the user does not specify the direction (angle) of the sound source (sound image) by the user interface unit 51, it is judged that the sound cannot be heard, and in a case where the user specifies the direction of the sound source by the user interface unit 51, it is judged that the sound can be heard.

In a case where it is judged in step S15 that the sound cannot be heard, the processing proceeds to step S16, and the parameter controller 52 increases the value of the parameter in the focused-on frequency band f of each of the signal processing units 41L and 41R for a person with hearing loss by one. The value of the parameter of the signal processing units 41L and 41R for a person with hearing loss represents, for example, a parameter that determines the relationship between the amplitude level of an input signal and the amplitude level of an output signal in the input and output characteristic of the multiband compressor. In the present embodiment, it is assumed that the input and output characteristic of the multiband compressor is set such that the greater the value of the parameter, the greater the amplitude level of an output signal with respect to the amplitude level of an input signal. For example, in a case where the sound data input to the signal processing units 41L and 41R for a person with hearing loss is fixed, the amplitude of the sound data output by the signal processing units 41L and 41R for a person with hearing loss increases as the value of the parameter increases. The processing proceeds from step S16 to step S19.

In a case where it is judged in step S15 that the sound can be heard, the processing proceeds to step S17, and the parameter controller 52 judges whether or not the direction of the sound source (sound image localization) perceived by the user is appropriate on the basis of the input information from the user interface unit 51. Specifically, in a case where the angle difference between the direction (angle) in which the test sound source is arranged with respect to the user's head in the virtual space and the direction (angle) of the sound source input by the user from the user interface unit 51 is equal to or smaller than a predetermined threshold, the parameter controller 52 judges that the sound image localization is appropriate, and in a case where the angle difference is larger than the threshold, the parameter controller 52 judges that the sound image localization is not appropriate.

In a case where it is judged in step S17 that the sound image localization is not appropriate, the processing proceeds to step S18, and the parameter controller 52 decreases the value of the parameter in the focused-on frequency band f of each of the signal processing units 41L and 41R for a person with hearing loss by one. The processing returns from step S18 to step S13.

In a case where it is judged in step S17 that the sound image localization is appropriate, the parameter controller 52 sets (determines) the value of the parameter (input and output characteristic of the multiband compressor) in the focused-on frequency band f of each of the signal processing units 41L and 41R for a person with hearing loss to the current value. The processing proceeds to step S19.

In step S19, the parameter controller 52 updates the frequency band f to be focused on to a frequency band given the next turn with respect to the order of the current frequency band. The processing proceeds from step S19 to step S20.

In step S20, the parameter controller 52 judges whether or not adjustment of the parameter (adjustment of the input and output characteristic of the multiband compressor) in all frequency bands (frequency bands that are adjustment targets) has been terminated. That is, in a case where the order of the frequency band f to be focused on updated in step S19 exceeds the final order, the parameter controller 52 judges that parameter adjustment in all the frequency bands that are adjustment targets has been terminated. In a case where the order of the frequency band f to be focused on does not exceed the final order, the parameter controller 52 judges that parameter adjustment in all the frequency bands that are adjustment targets has not been terminated.

In a case where it is judged in step S20 that parameter adjustment in all the frequency bands that are adjustment targets has not been terminated, the processing returns to step S13, and steps S13 to S20 are repeated.

In a case where it is judged in step S20 that parameter adjustment in all the frequency bands that are adjustment targets has been terminated, the process flow of this flowchart is terminated.

Adjustment of the parameter for signal processing for a person with hearing loss of the signal processing units 41L and 41R for a person with hearing loss may be repeatedly executed while changing the direction in which the test sound source is arranged to a plurality of different directions, and adjustment of the parameter for signal processing for a person with hearing loss may be ended in a case where the values of the parameters for signal processing for a person with hearing loss converge.

According to adjustment of the parameter for signal processing for a person with hearing loss as described above, it is possible to provide sound in 3D audio having sound image localization suitable for the user (person with hearing loss).

Note that since the burden on the user is heavy in a case where adjustment of the input and output characteristic of the multiband compressor is obtained in a brute-force manner, the user may take an A/B test and adjustment may be performed by reinforcement learning. At that time, as A, sound data generated by the initial value before adjustment of the parameter for signal processing for a person with hearing loss is started is presented to the user, and as B, sound data generated by using the parameter for signal processing for a person with hearing loss being adjusted is presented to the user, and the user selects one of them that has sound image localization which can be heard more appropriately.

Regarding the direction of the sound source specified by the user by the user interface unit 51, in a case where the direction of the sound source perceived by the user varies, or in a case where the direction of the sound source is specified from the motion of the head by using the head mounted display 63 as illustrated in FIG. 6, a case where the direction of the sound source specified by the user is not clear and reliability varies is considered. In such a case, the angle θ of the sound source specified by the user may have the angle range of +δ, or a numerical value of 0 to 1 may be given as the reliability, and then reinforcement learning may be performed.

<Processing of Reproducing Plurality of Pieces of Sound Source Data for Person with Normal Hearing Corresponding to Plurality of Sound Sources>

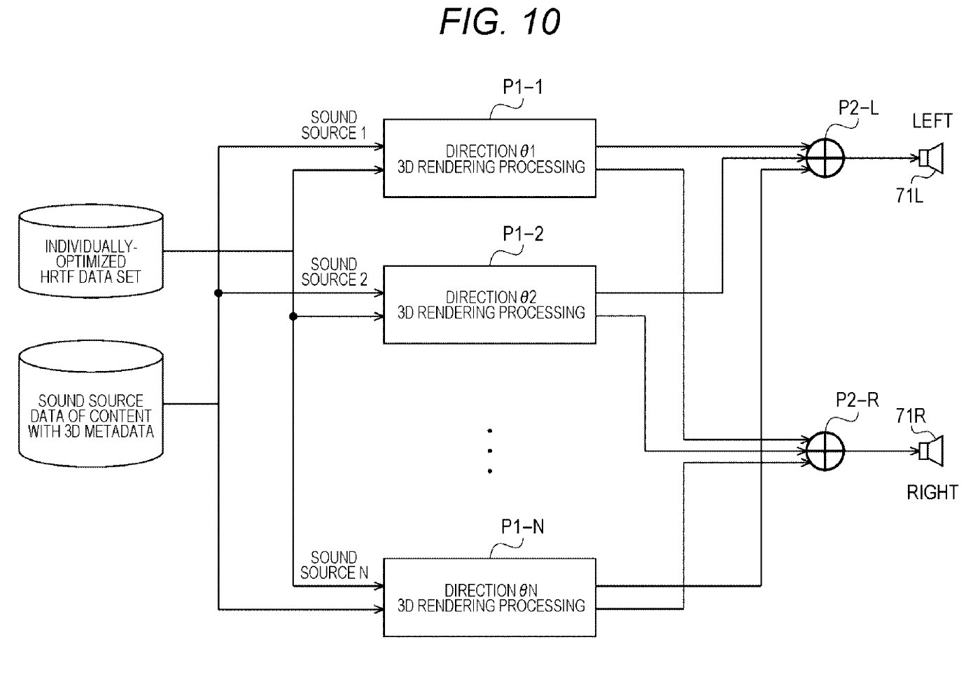

FIG. 10 is an explanatory diagram for explaining processing of reproducing a plurality of pieces of sound source data for a person with normal hearing corresponding to a plurality of sound sources.

It is assumed that at the time of reproducing the sound source data of content with 3D metadata, a plurality of sound sources 1 to N is arranged at a plurality of locations (directions) in the virtual space, and a person with normal hearing hears sound source data (sound waves) generated by the sound sources 1 to N in 3D audio. Directions (angles) of the sound sources 1 to N with respect to the user's head in the virtual space are defined as angles θ1 to θN, respectively. In this case, the 3D rendering processing unit 31 individually performs 3D rendering processing on pieces of sound source data of the sound sources 1 to N on the basis of the pieces of sound source data of the sound sources 1 to N, and generates pieces of sound data in 3D audio. That is, the 3D rendering processing unit 31 performs 3D rendering processing P1-1 to P1-N in the directions θ1 to θN on the pieces of sound source data of the sound sources 1 to N, and generates pieces of left sound data and pieces of right sound data. At this time, the 3D rendering processing unit 31 acquires the head related transfer function corresponding to each of the angles θ1 to θN of the sound sources from the individually-optimized HRTF data set and uses the head-related transfer function for generation of sound data.

The 3D rendering processing unit 31 adds (sums up) the pieces of left sound data generated by the 3D rendering processing P1-1 to P1-N in the directions θ1 to θN by addition processing P2-L to generate one piece of left sound data (for one channel). The sound data generated by the addition processing P2-L is output from the left sound output unit 71L such as an earphone or a headphone used by a person with normal hearing. Similarly, the 3D rendering processing unit 31 adds the pieces of right sound data generated by the 3D rendering processing P1-1 to P1-N in the directions θ1 to θN by addition processing P2-R to generate one piece of right sound data. The sound data generated by the addition processing P2-R is output from the right sound output unit 71L such as an earphone or a headphone used by the person with normal hearing.

<First Form of Processing of Reproducing Plurality of Pieces of Sound Source Data for Person with Hearing Loss Corresponding to Plurality of Sound Sources>

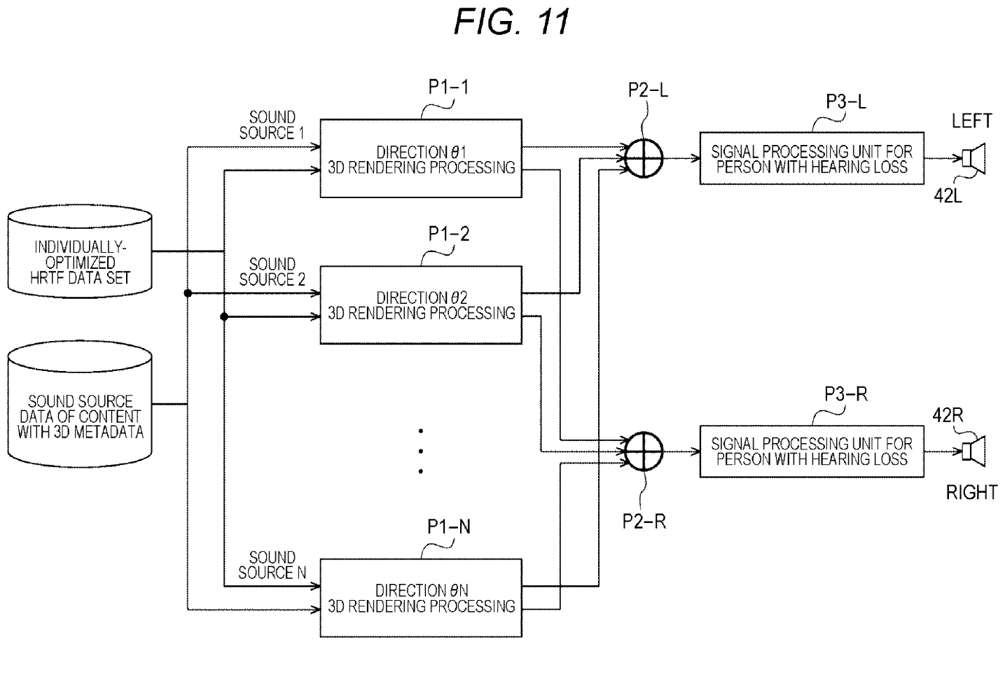

FIG. 11 is an explanatory diagram for explaining a first form of processing of reproducing a plurality of pieces of sound source data for a person with hearing loss.

Similarly to the case described in FIG. 10, it is assumed that at the time of reproducing sound source data of content with 3D metadata, the plurality of sound sources 1 to N is arranged at a plurality of locations (directions) in the virtual space. Directions (angles) of the sound sources 1 to N with respect to the user's head in the virtual space are defined as angles θ1 to θN, respectively. Regarding this, it is assumed that a person with hearing loss hears pieces of the sound source data generated by the sound sources 1 to N in 3D audio. In this case, similarly to the case of FIG. 10, the 3D rendering processing unit 31 performs the 3D rendering processing P1-1 to P1-N in the directions θ1 to θN on the pieces of sound source data of the sound sources 1 to N, and generates pieces of left sound data and pieces of right sound data. At this time, the 3D rendering processing unit 31 acquires the head related transfer function corresponding to each of the angles θ1 to θN of the sound sources from the individually-optimized HRTF data set and uses the head-related transfer function for generation of sound data.

Similarly to the case of FIG. 10, the 3D rendering processing unit 31 adds the pieces of left sound data generated by the 3D rendering processing P1-1 to P1-N in the directions θ1 to θN by the addition processing P2-L and adds the pieces of right sound data generated by the 3D rendering processing P1-1 to P1-N in the directions θ1 to ON by the addition processing P2-R, to generate one piece of left sound data and one piece of right sound data. The pieces of sound data generated by the addition processing P2-L and the sound data generated by the addition processing P2-R are supplied to the signal processing unit 41L for a person with hearing loss and the signal processing unit 41R for a person with hearing loss, respectively.

The signal processing unit 41L for a person with hearing loss executes processing of the multiband compressor by signal processing P3-L for a person with hearing loss on the left sound data from the addition processing P2-L to generate left sound data for a person with hearing loss. Similarly, the signal processing unit 41R for a person with hearing loss executes processing of the multiband compressor by signal processing P3-R for a person with hearing loss on the right sound data from the addition processing P2-R to generate right sound data for a person with hearing loss. In the signal processing P3-L and P3-R for a person with hearing loss at this time, the value of the parameter adjusted (set) in advance by the method described in FIG. 9 or the like is set as the parameter of the signal processing units 41L and 41R for a person with hearing loss.

The signal processing units 41L and 41R for a person with hearing loss output the pieces of sound data generated by the signal processing P3-L and P3-R for a person with hearing loss from the sound output units 42L and 42R, respectively.

Note that, in a case where pieces of sound data in 3D audio of N pieces of sound source data are generated for a person with normal hearing on the basis of sound source data of content with 3D metadata as illustrated in FIG. 10, the number of pieces of sound source data may be made smaller than N for a person with hearing loss so that the person with hearing loss can easily perceive sound image localization.

<Second Form of Processing of Reproducing Plurality of Pieces of Sound Source Data for Person with Hearing Loss Corresponding to Plurality of Sound Sources>

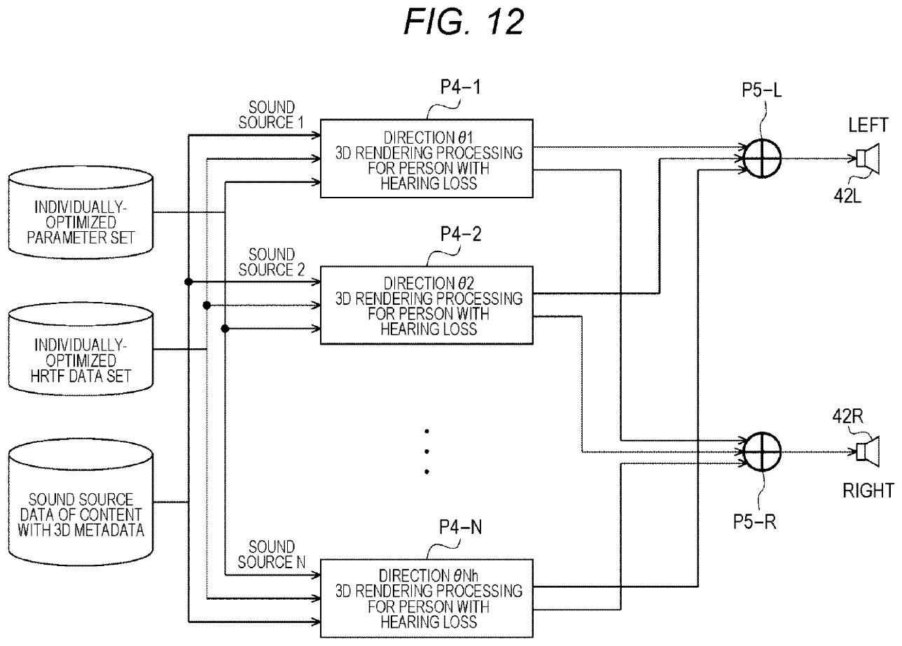

FIG. 12 is an explanatory diagram for explaining a second form of the processing of reproducing a plurality of pieces of sound source data for a person with hearing loss corresponding to a plurality of sound sources.

Similarly to the case described in FIG. 11, it is assumed that at the time of reproducing the sound source data of content with 3D metadata, the plurality of sound sources 1 to N is arranged at a plurality of locations (directions) in the virtual space. Directions (angles) of the sound sources 1 to N with respect to the user's head in the virtual space are defined as angles θ1 to θN, respectively. It is assumed that a person with hearing loss hears the sound source data (sound) generated by the sound sources 1 to N in 3D audio.

In this case, the 3D rendering processing unit 31 and the signal processing units 41L and 41R for a person with hearing loss perform 3D rendering processing P4-1 to P4-N for a person with hearing loss in the directions θ1 to θN on pieces of the sound source data of the sound sources 1 to N, respectively.

The 3D rendering processing P4-1 to P4-N for a person with hearing loss in the directions θ1 to θN will be described focusing on 3D rendering processing P4-n for a person with hearing loss in the direction θn (n is any one of 1 to N). In the 3D rendering processing P4-n for a person with hearing loss in the direction θn, similarly to FIGS. 10 and 11, the 3D rendering processing unit 31 performs 3D rendering processing in the direction θn on the sound source data of the sound source at the angle θn, and generates left sound data and right sound data in 3D audio. At this time, the 3D rendering processing unit 31 acquires the head related transfer function corresponding to the angle θn from the individually-optimized HRTF data set to generate sound data.

In the 3D rendering processing P4-n for a person with hearing loss in the direction θn, the signal processing units 41L and 41R for a person with hearing loss further execute the processing of the multiband compressor on the left sound data and the right sound data generated by the 3D rendering processing in the direction θn to generate left sound data and right sound data for a person with hearing loss, respectively. At this time, the value of the parameter adjusted (set) in advance is set as the parameter of the signal processing units 41L and 41R for a person with hearing loss. However, since it can be assumed that the appropriate parameter of the signal processing units 41L and 41R for a person with hearing loss differs according to the angle θn of the sound source, the value of the parameter adjusted by a method to be described later is set. Regarding the parameter of the signal processing units 41L and 41R for a person with hearing loss, the value of the parameter adjusted by the method or the like described in FIG. 9 may be set. By the 3D rendering processing P4-n for a person with hearing loss in the direction θn as described above, left sound data and right sound data for a person with hearing loss for the sound source at the angle θn are generated.

The 3D rendering processing P4-1 to P4-N for a person with hearing loss in the directions θ1 to θN generate left sound data and right sound data for a person with hearing loss for the sound sources at the angles θ1 to θN.

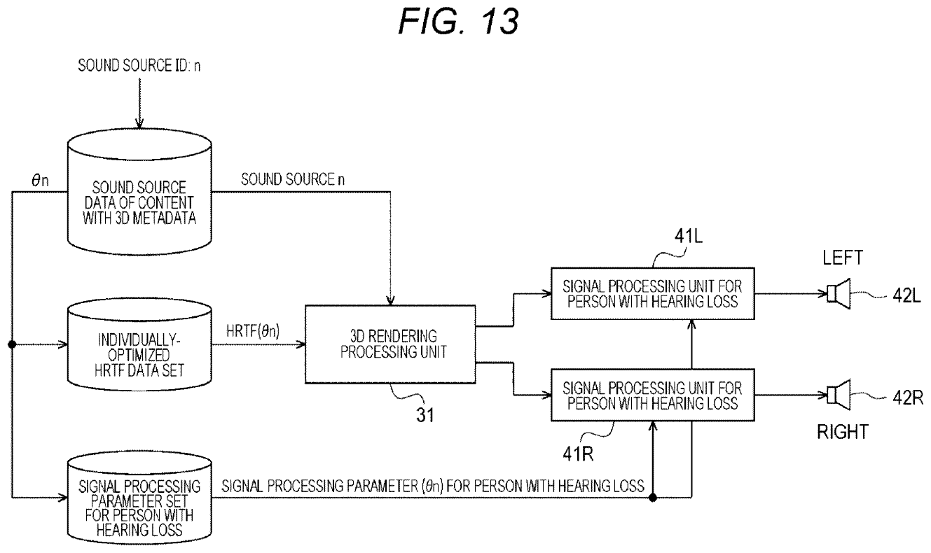

The signal processing unit 41L for a person with hearing loss or a processing unit at a subsequent stage, not illustrated, adds pieces of the left sound data for a person with hearing loss generated by the 3D rendering processing P4-1 to P4-N for a person with hearing loss in the directions θ1 to θN by addition processing P5-L to generate one piece of left sound data, and the signal processing unit 41R for a person with hearing loss or a processing unit at a subsequent stage, not illustrated, adds pieces of the right sound data for a person with hearing loss generated by the 3D rendering processing P4-1 to P4-N for a person with hearing loss in the directions θ1 to θN by addition processing P5-R to generate one piece of right sound data. The signal processing units 41L and 41R for a person with hearing loss or the processing units at a subsequent stage output the left sound data and the right sound data generated by the addition processing P5-L and P5-R from the sound output units 42L and 42R, respectively.

<Description of adjustment of parameter for signal processing for person with hearing loss in second form of processing of reproducing plurality of pieces of voice data> FIG. 13 is an explanatory diagram for explaining adjustment of the parameter for signal processing for a person with hearing loss used in the second form of the processing of reproducing a plurality of pieces of voice data. Note that, portions corresponding to those in the information processing system 1 in FIG. 2 are denoted by the same reference signs, and detailed description thereof is omitted.

In FIG. 13, the signal processing units 41L and 41R for a person with hearing loss acquire values of parameters (input and output characteristic of the multiband compressor) corresponding to the angles θ1 to θN from the parameter set for signal processing for a person with hearing loss in the signal processing (processing of the multiband compressor) for a person with hearing loss in the 3D rendering processing P4-1 to P4-N for a person with hearing loss in the directions θ1 to θN in FIG. 12. The parameter set for signal processing for a person with hearing loss is generated in advance by a method to be described later and stored in a storage unit, not illustrated, of the external cooperation device 11 or the hearing aid 12.

For example, in the signal processing for a person with hearing loss when executing the 3D rendering processing P4-n for a person with hearing loss in the direction θn (n is any one of 1 to N), the signal processing units 41L and 41R for a person with hearing loss acquire the value of the parameter (parameter θn for signal processing for a person with hearing loss) corresponding to the angle θn from the parameter set for signal processing for a person with hearing loss, and execute the signal processing for a person with hearing loss by the multiband compressor having an input and output characteristic corresponding to the acquired value of the parameter.

### <Description of Generation of Parameter Set in Second Form of Processing of Reproducing Plurality of Pieces of Voice Data>

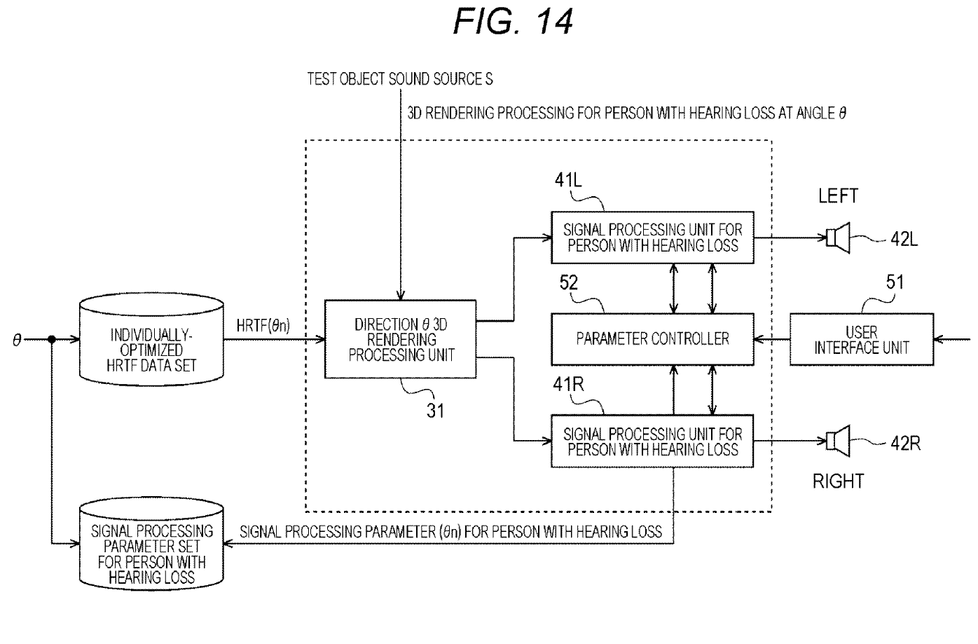

FIG. 14 is an explanatory diagram for explaining generation of a parameter set for signal processing for a person with hearing loss in the second form of the processing of reproducing the plurality of pieces of voice data. Note that, portions corresponding to those in the information processing system 1 in FIG. 2 are denoted by the same reference signs and are parameters for signal processing for a person with hearing loss, and detailed description thereof is omitted.

It is assumed that directions (angles) of a plurality of sound sources corresponding to values of a plurality of parameters for signal processing for a person with hearing loss included in the parameter set for signal processing for a person with hearing loss in FIG. 13 are represented by angles θ (θ is a variable).

The parameter controller 52 determines an appropriate value of the parameter for signal processing for a person with hearing loss corresponding to the angle θ of the sound source when generating the parameter set for signal processing for a person with hearing loss. At this time, it is assumed that a test sound source is arranged as a test object sound source S in the direction of an angle θ with respect to the user's head in the virtual space, and test sound source data is generated from the sound source. The 3D rendering processing unit 31 executes 3D rendering processing on the sound source data of the test object sound source S by using the head related transfer function corresponding to the angle θ, and generates left sound data and right sound data in 3D audio. The left sound data and right sound data generated by the 3D rendering processing unit 31 are supplied to the signal processing units 41L and 41R for a person with hearing loss, respectively.

The value of the parameter specified from the parameter controller 52 is set for each of the signal processing units 41L and 41R for a person with hearing loss. The signal processing units 41L and 41R for a person with hearing loss execute signal processing (processing of the multiband compressor) for a person with hearing loss and generate left sound data and right sound data for a person with hearing loss, respectively. The generated left sound data and right sound data are output as sound waves from the sound output units 42L and 42R, respectively.

On the basis of input information from the user interface unit 51, the parameter controller 52 adjusts the value of the parameter (input and output characteristic of the multiband compressor) corresponding to the angle θ currently set for the signal processing units 41L and 41R for a person with hearing loss to be appropriate while judging whether or not the value of the parameter is proper. In a case where an appropriate value of the parameter is obtained, the parameter controller 52 stores the value of the parameter in the storage unit, not illustrated, as the value of the parameter corresponding to the angle θ. The parameter controller 52 changes the angle θ to acquire an appropriate value of the parameter corresponding to the angle θ and stores the value in the storage unit, thereby generating a parameter set for signal processing for a person with hearing loss.

In a case where a plurality of pieces of sound source data of content with 3D metadata is reproduced, 3D rendering processing for a person with hearing loss in the direction θ is executed correspondingly to the angle θ of each of the sound sources. In the 3D rendering processing for a person with hearing loss in the direction θ, the head related transfer function corresponding to the angle θ is supplied from the individually-optimized HRTF data set to the 3D rendering processing unit 31, and 3D rendering processing is executed on the sound source data of the sound source at the angle θ. In the 3D rendering processing for a person with hearing loss in the direction θ, the value of the parameter corresponding to the angle θ is supplied from the parameter set for signal processing for a person with hearing loss to the signal processing units 41L and 41R for a person with hearing loss, and signal processing for a person with hearing loss is executed.

### <Description of Method of Adjusting Parameter in Second Form of Processing of Reproducing Plurality of Pieces of Voice Data>

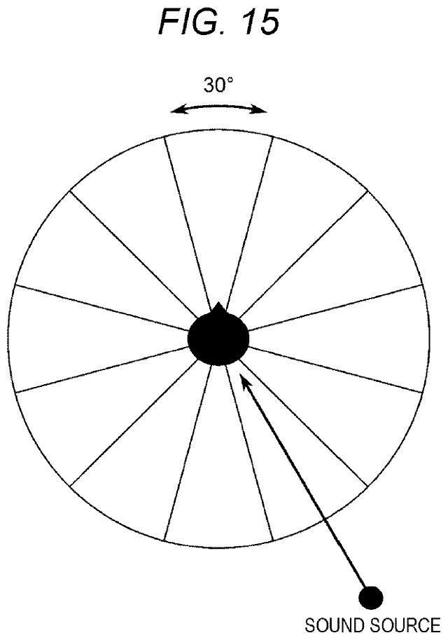

FIG. 15 is a diagram illustrating a method of adjusting the parameter for signal processing for a person with hearing loss in the second form of processing of reproducing the plurality of pieces of voice data.

In FIG. 15, the position of the user in the virtual space is set as the center of the circle. The line segments connecting the center of the circle and the points on the circumference are drawn at angular intervals at which the central angle of the adjacent line segments is 30 degrees. In FIG. 15, it is assumed that the sound source is arranged in a direction that divides the central angle of adjacent line segments into halves. At this time, it is assumed that the value of the parameter for signal processing for a person with hearing loss corresponding to each angle θ is adjusted while changing the angle θ of the sound source at intervals of 30 degrees from 0 degrees.

### <Description of Procedure of First Form of Parameter Adjustment in Second Form of Processing of Reproducing Plurality of Pieces of Voice Data>

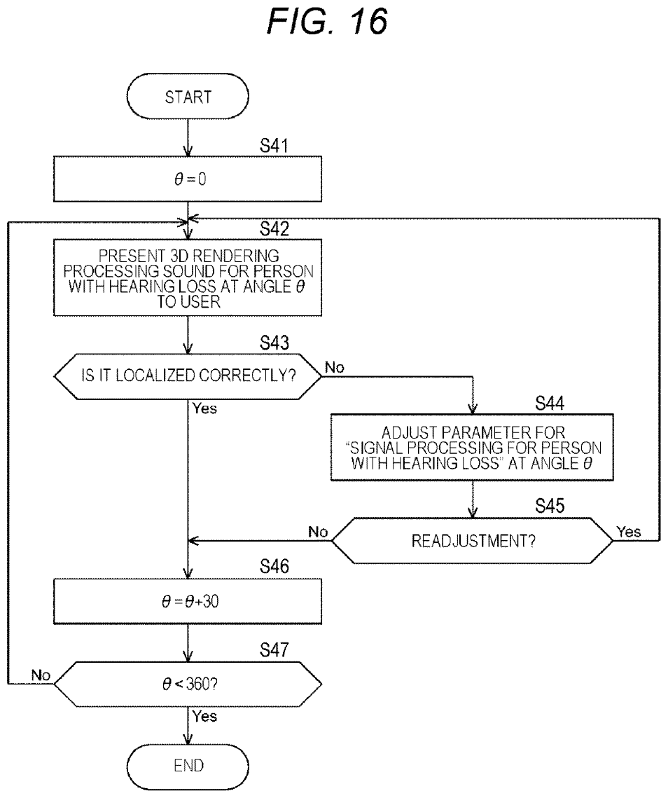

FIG. 16 is a flowchart exemplifying a procedure of a first form of adjustment of the parameter for signal processing for a person with hearing loss in the second form of the processing of reproducing the plurality of pieces of voice data.

In step S41, the parameter controller 52 sets the angle θ of the sound source to 0 degrees as an initial value. The processing proceeds from step S41 to step S42.

In step S42, the parameter controller 52 causes the 3D rendering processing unit 31 and the signal processing units 41L and 41R for a person with hearing loss to execute 3D rendering processing for a person with hearing loss in the direction θ on the test sound source (test object sound source S) at the angle θ. As a result, left sound data and right sound data for a person with hearing loss are generated. Note that, in the 3D rendering processing for a person with hearing loss in the direction θ, the 3D rendering processing unit 31 uses the head related transfer function corresponding to the angle θ in the individually-optimized HRTF data set. The signal processing units 41L and 41R for a person with hearing loss use the initial value of the parameter for signal processing for a person with hearing loss corresponding to the angle θ in the parameter set for signal processing for a person with hearing loss. The initial value of the parameter for signal processing for a person with hearing loss may be the value of the parameter of the hearing aid usually used by the user, may be the value of the parameter adjusted for another user, or may be another value. Left sound data and right sound data generated by the 3D rendering processing for a person with hearing loss in the direction θ are output from the sound output units 42L and 42R for a person with hearing loss, respectively, and are presented to the user. The processing proceeds from step S42 to step S43.

In step S43, the parameter controller 52 judges whether or not the angle (sound image localization) of the sound source perceived by the user is appropriate on the basis of input information from the user interface unit 51. Specifically, in a case where the angle difference between the angle at which the sound source is arranged with respect to the user's head in the virtual space and the angle of the sound source input by the user from the user interface unit 51 is equal to or smaller than a predetermined threshold, the parameter controller 52 judges that the sound image localization is appropriate, and in a case where the angle difference is larger than the threshold, the parameter controller 52 judges that the sound image localization is not appropriate.

In a case where it is judged in step S43 that the sound image localization is not appropriate, the processing proceeds to step S44, and the parameter controller 52 adjusts the parameter for signal processing for a person with hearing loss by the method described in FIG. 9 or the like. The processing proceeds from step S44 to step S45.

In step S45, the parameter controller 52 judges whether or not to perform readjustment on the basis of input information from the user interface unit 51. Note that whether or not to perform readjustment may be specified by the user using the user interface unit 51 or may be forcibly performed by the parameter controller 52.

In a case where it is judged in step S45 that readjustment is to be performed, the processing returns to step S42 and repeats from step S42. In a case where it is judged not to perform readjustment in step S45, the processing proceeds to step S46.

In a case where it is judged in step S43 that the sound image localization is appropriate, the processing proceeds to step S66. In step S46, the parameter controller 52 updates the angle θ of the sound source to a value obtained by adding 30 degrees to the current value. The processing proceeds from step S46 to step S47. In step S47, the parameter controller 52 judges whether or not the angle θ is less than 360 degrees.

In a case where it is judged in step S47 that the angle θ is less than 360 degrees, the processing returns to step S42 and repeats from step S42. In a case where it is judged in step S47 that the angle θ is not less than 360 degrees, the processing terminates the process flow of the present flowchart.

<Description of procedure of second form of parameter adjustment in second form of processing of reproducing plurality of pieces of voice data>

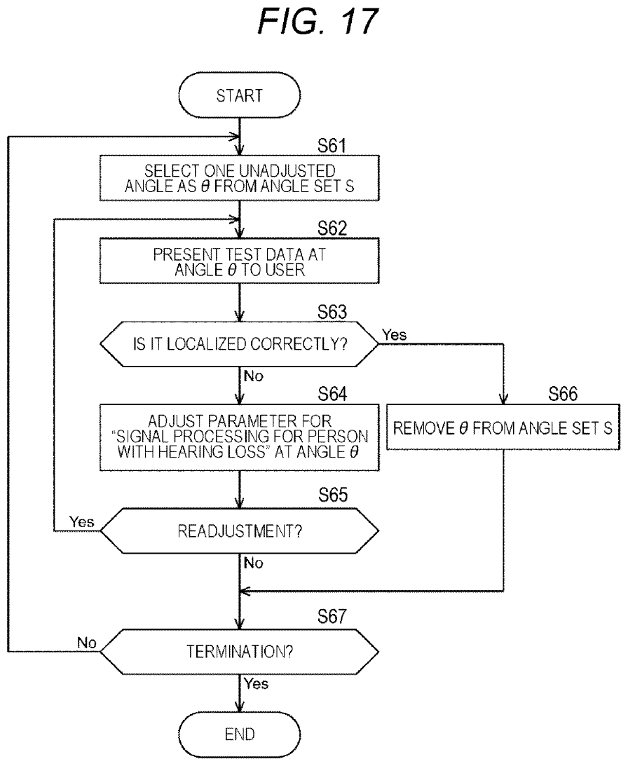

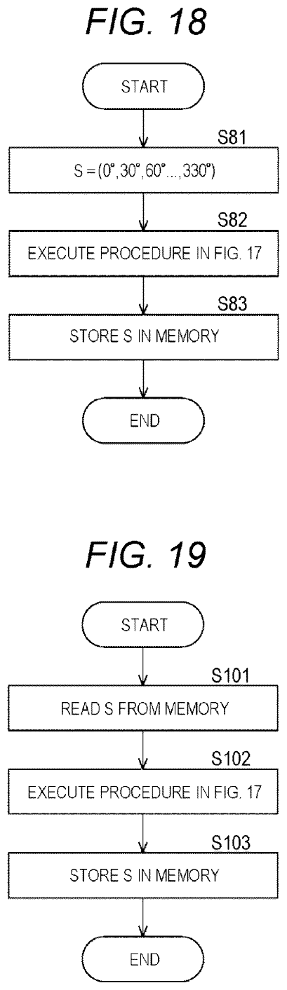

FIG. 17 is a flowchart exemplifying a procedure of a second form of the adjustment of the parameter for signal processing for a person with hearing loss in the second form of the processing of reproducing the plurality of pieces of voice data.

In step S61, the parameter controller 52 sets the angles θ at 30-degree intervals from 0 degrees to 330 degrees with respect to the angle θ of the sound source as initial values of one set (angle set) S. The parameter controller 52 selects from the angle set S any one angle θ for which the parameter for signal processing for a person with hearing loss is unadjusted. The processing proceeds from step S61 to step S62.

The parameter controller 52 causes the 3D rendering processing unit 31 and the signal processing units 41L and 41R for a person with hearing loss to execute 3D rendering processing for a person with hearing loss in the direction θ on the test sound source data generated from a sound source in a case where the sound source is arranged at the angle θ selected in step S62. As a result, the generated left sound data and right sound data for a person with hearing loss are output from the sound output units 42L and 42R, respectively, and are presented to the user. The processing proceeds from step S62 to step S63.

In step S63, the parameter controller 52 judges whether or not the angle (sound image localization) of the sound source perceived by the user is appropriate on the basis of input information from the user interface unit 51.

In a case where it is judged in step S63 that the sound image localization is not appropriate, the processing proceeds to step S64, and the parameter controller 52 adjusts the parameter for signal processing for a person with hearing loss corresponding to the angle θ by the method described in FIG. 9 or the like. The processing proceeds from step S64 to step S65.

In step S65, the parameter controller 52 judges whether or not to perform readjustment on the basis of input information from the user interface unit 51. Note that whether or not to perform readjustment may be specified by the user using the user interface unit 51 or may be forcibly performed by the parameter controller 52.

In a case where it is judged in step S65 that readjustment is to be performed, the processing returns to step S62 and repeats from step S62. In a case where it is judged in step S65 not to perform readjustment, the processing proceeds to step S67.

In a case where it is judged in step S63 that the sound image localization is appropriate, the processing proceeds to step S66, and the parameter controller 52 removes the angle θ from the angle set S. The processing proceeds from step S66 to step S67.

In step S67, the parameter controller 52 judges whether or not to terminate the processing. That is, the parameter controller 52 judges not to terminate the processing in a case where there is an angle for which the parameter for signal processing for a person with hearing loss is not adjusted in the angle set S, and judges to terminate the processing in a case where there is no angle for which the parameter for signal processing for a person with hearing loss is not adjusted.

In a case where it is judged in step S67 not to terminate the processing, the processing returns to step S61 and repeats from step S61. In a case where it is judged in step S67 to terminate the processing, the processing terminates the process flow of the present flowchart.

FIG. 18 is a flowchart exemplifying an overall procedure of adjustment of the parameter for signal processing for a person with hearing loss using the procedure (formalities) of FIG. 17.

In FIG. 18, in step S81, the parameter controller 52 sets the angle set S as a set of angles of every 30 degrees from 0 degrees to 330 degrees. The processing proceeds from step S81 to step S82.

In step S82, the parameter controller 52 executes the formalities (processing) illustrated in the flowchart of FIG. 17. At this time, in a case where step S66 in FIG. 17 is executed, the angle θ is excluded from the angle set S. The angle θ excluded from the angle set S is an angle at which sound image localization is judged to be appropriate. The processing proceeds from step S82 to step S83.

In step S83, the parameter controller 52 stores the angle set S in the storage unit, not illustrated. After step 83 is executed, the processing terminates the process flow of the present flowchart.

FIG. 19 is a flowchart exemplifying a procedure in a case where the parameter for signal processing for a person with hearing loss corresponding to an angle included in the angle set S stored by the parameter controller 52 in FIG. 18 is adjusted again. In the flowchart of FIG. 19, adjustment is performed only for the parameter for signal processing for a person with hearing loss corresponding to the angle of the sound source for which adjustment of the parameter for signal processing for a person with hearing loss was not be able to be appropriately performed in FIG. 18. As a result, the burden on the user required to adjust the parameter is reduced.

In step S101, the parameter controller 52 reads the angle set S stored in step S83 of FIG. 18 from the storage unit. That is, by the angle set S, the angles of the sound source the sound image localization of which is judged to be not appropriate are acquired. The processing proceeds from step S101 to step S102.

In step S102, the parameter controller 52 executes the procedure of FIG. 17 on the angle set S acquired in step S101. At this time, in a case where step S66 in FIG. 17 is executed, the angle θ is excluded from the angle set S. The processing proceeds from step S102 to step S103.

In step S103, the parameter controller 52 stores the angle set S in the storage unit, not illustrated. After step 83 is executed, the processing terminates the process flow of the present flowchart.

### <Program>

The above-described series of processing in the information processing system 1 can be executed by hardware or can be executed by software. In a case where the series of processing is executed by the software, a program constituting the software is installed on a computer. Here, examples of the computer include a computer incorporated in dedicated hardware, and a general-purpose personal computer capable of executing various functions by installing various programs, for example.

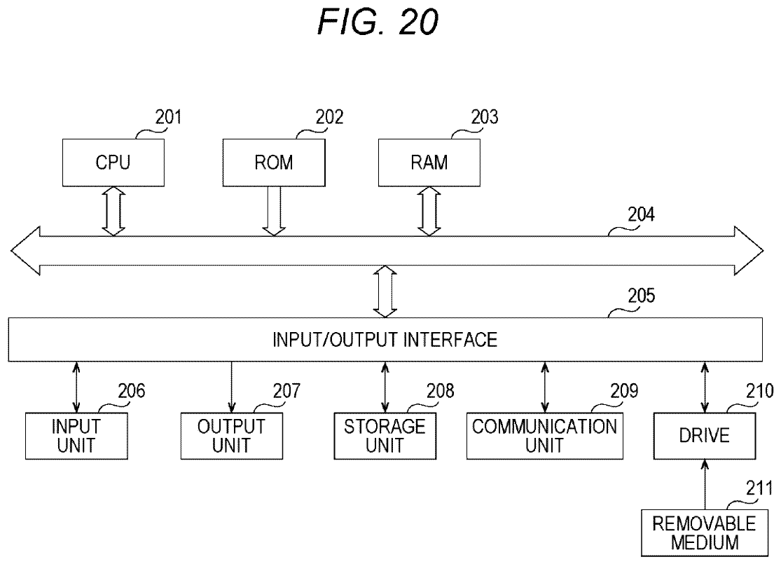

FIG. 20 is a block diagram illustrating a configuration example of the hardware of the computer in a case where the computer executes each processing executed by the information processing system 1 with a program.

In the computer, a central processing unit (CPU) 201, a read only memory (ROM) 202, and a random access memory (RAM) 203 are mutually connected by a bus 204.

An input/output interface 205 is further connected to the bus 204. The input/output interface 205 is connected to an input unit 206, an output unit 207, a storage unit 208, a communication unit 209, and a drive 210.

The input unit 206 includes a keyboard, a mouse, a microphone, and the like. The output unit 207 includes a display, a speaker, and the like. The storage unit 208 includes a hard disk, a non-volatile memory and the like. The communication unit 209 includes a network interface, and the like. The drive 210 drives a removable medium 211 such as a magnetic disk, an optical disk, a magneto-optical disk, or a semiconductor memory.

In the computer configured as described above, for example, the CPU 201 loads the program stored in the storage unit 208 into the RAM 203 via the input/output interface 205 and the bus 204 and executes the program, thereby performing the above-described series of processing.

The program executed by the computer (CPU 201) can be provided by being recorded on the removable medium 211 as a package medium or the like, for example. Furthermore, the program can be provided via a wired or wireless transmission medium such as a local area network, the Internet, or digital broadcasting.

In the computer, the program can be installed in the storage unit 208 via the input/output interface 205 by loading the removable medium 211 in the drive 210. Furthermore, the program can be received by the communication unit 209 via a wired or wireless transmission medium and installed on the storage unit 208. Additionally, the program may be installed in advance on the ROM 202 and the storage unit 208.

Note that the program executed by the computer may be a program that performs processing in a time-series manner in the order described in the present description, or may be a program that performs processing in parallel or at necessary timing such as when a call is made.

The present technology can also have the following configurations.

(1)

An information processing device including:
a rendering processing unit that generates stereophonic sound data having sound image localization on the basis of a direction of a sound source arranged in a virtual space; and
a signal processing unit that performs data conversion processing corresponding to an auditory characteristic of a user on the stereophonic sound data generated by the rendering processing unit and generates output sound data to be heard by the user.
   (2)

The information processing device according to (1), in which
the rendering processing unit generates the stereophonic sound data by using a head related transfer function corresponding to the direction of the sound source.
   (3)

The information processing device according to (2), in which
the rendering processing unit uses the head related transfer function optimized for the user.
   (4)

The information processing device according to any one of (1) to (3)), in which
the signal processing unit generates the output sound data from the stereophonic sound data by using a compressor having a predetermined input and output characteristic.
   (5)

The information processing device according to (4), in which
the signal processing unit uses the compressor having the input and output characteristic corresponding to the auditory characteristic of the user.
   (6)

The information processing device according to (4) or (5), in which
the signal processing unit uses the compressor capable of setting or changing the input and output characteristic for each frequency band of the stereophonic sound data.
   (7)

The information processing device according to any one of (1) to (6) further including
a parameter control unit that adjusts a parameter for determining a characteristic of data conversion processing in the signal processing unit.
   (8)

The information processing device according to (7), in which
the parameter control unit adjusts the parameter so that a direction of a test sound source arranged, the direction being specified by the user who has heard the output sound data with respect to the test sound source in the virtual space coincides with a direction of the test sound source in the virtual space.
   (9)

The information processing device according to (7) or (8), in which
the parameter control unit adjusts the parameter for each frequency band of the stereophonic sound data.
   (10)

The information processing device according to any one of (1) to (9), in which
the signal processing unit performs the data conversion processing on the stereophonic sound data obtained by adding the stereophonic sound data generated by the rendering processing unit for each of a plurality of the sound sources.
   (11)

The information processing device according to any one of (1) to (9), in which
the signal processing unit generates the output sound data by data conversion processing of a characteristic corresponding to a direction of the sound source for each of pieces of the stereophonic sound data generated by the rendering processing unit for each of a plurality of the sound sources, and generates the output sound data to be heard by the user by adding pieces of the output sound data that have been generated.
   (12)

The information processing device according to any one of (8) to (11) further including
a user interface unit that specifies the direction of the test sound source on the basis of the output sound data heard by the user.
   (13)

The information processing device according to any one of (1) to (12), in which
the signal processing unit performs data conversion processing corresponding to an auditory characteristic of a person with hearing loss in a case where the user is the person with hearing loss.
   (14)

An information processing method for an information processing device including a rendering processing unit and a signal processing unit, the information processing method including:

by the rendering processing unit, generating stereophonic sound data having sound image localization on the basis of a direction of a sound source arranged in a virtual space; and
by the signal processing unit, performing data conversion processing corresponding to an auditory characteristic of a user on the stereophonic sound data generated by the rendering processing unit and generating output sound data to be heard by the user.
   (15)

A program causing a computer to function as:
a rendering processing unit that generates stereophonic sound data having sound image localization on the basis of a direction of a sound source arranged in a virtual space; and
a signal processing unit that performs data conversion processing corresponding to an auditory characteristic of a user on the stereophonic sound data generated by the rendering processing unit and generates output sound data to be heard by the user.

### REFERENCE SIGNS LIST

1, 1-1, 1-2 Information processing system
1 Sound source
11 External cooperation device
12 Hearing aid
12L Left ear hearing aid
12R Right ear hearing aid
31 3D rendering processing unit
41L, 41R Signal processing unit for a person with hearing
loss
42L, 42R Sound output unit
51 User interface unit
52 Parameter controller

1. An information processing device comprising:
a rendering processing unit that generates stereophonic sound data having sound image localization on a basis of a direction of a sound source arranged in a virtual space; and
a signal processing unit that performs data conversion processing corresponding to an auditory characteristic of a user on the stereophonic sound data generated by the rendering processing unit and generates output sound data to be heard by the user.

2. The information processing device according to claim 1, wherein
the rendering processing unit generates the stereophonic sound data by using a head related transfer function corresponding to the direction of the sound source.

3. The information processing device according to claim 2, wherein
the rendering processing unit uses the head related transfer function optimized for the user.

4. The information processing device according to claim 1, wherein
the signal processing unit generates the output sound data from the stereophonic sound data by using a compressor having a predetermined input and output characteristic.

5. The information processing device according to claim 4, wherein
the signal processing unit uses the compressor having the input and output characteristic corresponding to the auditory characteristic of the user.

6. The information processing device according to claim 4, wherein
the signal processing unit uses the compressor capable of setting or changing the input and output characteristic for each frequency band of the stereophonic sound data.

7. The information processing device according to claim 1 further comprising a parameter control unit that adjusts a parameter for determining a characteristic of data conversion processing in the signal processing unit.

8. The information processing device according to claim 7, wherein
the parameter control unit adjusts the parameter so that a direction of a test sound source, the direction being specified by the user who has heard the output sound data with respect to the test sound source arranged in the virtual space coincides with a direction of the test sound source in the virtual space.

9. The information processing device according to claim 7, wherein
the parameter control unit adjusts the parameter for each frequency band of the stereophonic sound data.

10. The information processing device according to claim 1, wherein
the signal processing unit performs the data conversion processing on the stereophonic sound data obtained by adding the stereophonic sound data generated by the rendering processing unit for each of a plurality of the sound sources.

11. The information processing device according to claim 1, wherein
the signal processing unit generates the output sound data by data conversion processing of a characteristic corresponding to the direction of the sound source for each of pieces of the stereophonic sound data generated by the rendering processing unit for each of a plurality of the sound sources, and generates the output sound data to be heard by the user by adding pieces of the output sound data that have been generated.

12. The information processing device according to claim 8 further comprising
a user interface unit that specifies the direction of the test sound source on a basis of the output sound data heard by the user.

13. The information processing device according to claim 1, wherein
the signal processing unit performs data conversion processing corresponding to an auditory characteristic of a person with hearing loss in a case where the user is the person with hearing loss.

14. An information processing method for an information processing device including a rendering processing unit and a signal processing unit, the information processing method comprising:
by the rendering processing unit, generating stereophonic sound data having sound image localization on a basis of a direction of a sound source arranged in a virtual space; and
by the signal processing unit, performing data conversion processing corresponding to an auditory characteristic of a user on the stereophonic sound data generated by the rendering processing unit and generating output sound data to be heard by the user.

15. A program causing a computer to function as:
a rendering processing unit that generates stereophonic sound data having sound image localization on a basis of a direction of a sound source arranged in a virtual space; and
a signal processing unit that performs data conversion processing corresponding to an auditory characteristic of a user on the stereophonic sound data generated by the rendering processing unit and generates output sound data to be heard by the user.
